(19) United States
(12) Patent Application Publication
(10) Pub. No.: US 2021/0201428 A1
(43) Pub. Date: Jul. 1, 2021

(54) SYSTEM AND METHOD FOR FACILITATING CONTACT BETWEEN PARTIES

(71) Applicant: Knok'd Inc., Ottawa (CA)

(72) Inventors: Derek HOOPER, Ottawa (CA); Dennis MOUNT, Ottawa (CA)

(21) Appl. No.: 17/260,149

(22) PCT Filed: Jul. 12, 2019
(86) PCT No.: PCT/CA2019/050965

§ 371 Date: Jan. 13, 2021

Related U.S. Application Data
(60) Provisional application No. 62/697,936, filed on Jul. 13, 2018.

(51) Int. Cl. G06Q 50/16; G06Q 10/10; G06Q 30/06; G06F 16/29

(52) U.S. Cl. CPC G06Q 50/16; G06F 16/29; G06Q 30/0631; G06Q 10/10

(57) ABSTRACT

Systems and methods relating to contact and interactions between a potential seller and a potential buyer of a selected property. A system receives input from a potential buyer indicating interest in a selected property. The system locates the property's address and determines the potential seller for the property. Contact is then initiated with the potential seller and the potential seller is provided with a code for accessing a dedicated communications channel with the potential buyer. Once the code is activated, the potential seller and the potential buyer can determine if there is enough interest to sell the property.

### TECHNICAL FIELD

The present invention relates to computer systems and methods. More specifically, the present invention relates to systems and methods for monitoring developments relating to specific properties and for facilitating interactions between potential property buyers and potential property sellers.

### BACKGROUND

The migration of traditional brick and mortar businesses into the online world has been proceeding apace since the advent of the Internet in the 1990s. Most businesses now have an online presence and, indeed, some businesses have nothing but an online presence. This has led to transformative changes in various businesses and business models.

Unfortunately, while some advances have been made, the real estate business is still mired in a traditional and passive way of doing business. Sellers list their properties and buyers are still slaved to these property listings to find properties. Currently, there is no way for buyers to express interest in properties that are not for sale or for properties that have not been listed as being for sale. Similarly, there is currently no easy way for people or organizations to track properties and to be notified if a property were to become publicly listed for sale. As well, there is no way, currently, for property owners to determine if there is any interest in the properties that they own without going through the bother of publicly listing the property as being for sale and engaging a realtor.

Based on the above, there is therefore a need for systems and methods that would facilitate interactions between potential property buyers and potential property sellers. Similarly, there is a need for systems and methods that allow for the tracking of developments concerning one or more properties. Such systems and methods would advantageously go far towards opening up the unlisted property market and would allow for limiting missed opportunities that currently occur with today's real property model.

### SUMMARY

The present invention provides systems and methods relating to contact and interactions between a potential seller and a potential buyer of a selected property. A system receives input from a potential buyer indicating interest in a selected property. The system locates the property's address and determines the potential seller for the property. Contact is then initiated with the potential seller and the potential seller is provided with a code for accessing a dedicated communications channel with the potential buyer. Once the code is activated, the potential seller and the potential buyer can determine if there is enough interest to sell the property. Conversely, potential sellers may claim an electronic mailbox or a message box on the system that is set up for the specific property. In this variant, potential buyers may be placed in contact with the potential seller by way of the mailbox.

In a first aspect, the present invention provides a system for facilitating interactions between at least one potential buyer of at least one property and at least one potential seller of said at least one property, the system comprising:
a user database for storing entries relating to said at least one potential buyer and said at least one potential seller;
a property database for storing entries relating to said at least one property;
a user database management module for managing said entries in said user database;
a property database management module for managing said entries in said property database;
a user database management module for managing said entries in said user database;
a contact module for initiating contact between said at least one potential buyer and said at least one potential seller;
a property location module for determining the or each location of said at least one property based on input from said at least one potential buyer;
a communications module for providing at least one communications channel between said at least one potential buyer and said at least one potential seller;
wherein
at least some of said entries in said property database are based on said the or each location of said at least one property.

In a second aspect, the present invention provides a method for facilitating contact between at least a potential buyer of a property and a potential seller of said property, the method comprising:
a) receiving input from said potential buyer, said input being indicative of an interest of said potential buyer in said property;
b) determining a location of said property based on said input from said potential buyer;
c) determining if said property has an entry in a property database;
d) in the event said property has an entry in said property database, determining said potential seller for said property;
e) in the event said property does not have an entry in said property database, creating an entry for said property in said property database and determining said potential seller for said property, said entry in said property database being based partially on said location of said property;
f) initiating contact with said potential seller and providing said potential seller with indicia that provides said potential seller access to a communications channel with said potential buyer.

In a third aspect, the present invention provides a method for monitoring a selected property, the method comprising:

a) receiving input from a user indicating an interest in said selected property;

b) determining a location of said selected property based on said input from said user;

c) determining if said selected property has an entry in a property database;

d) in the event said property does not have an entry in said property database, creating an entry for said property in said property database, said entry in said property database being based partially on said location of said property;

e) tracking developments relating to said selected property;

f) reporting said developments relating to said selected property to said user.

In a fourth aspect, the present invention provides a method for facilitating contact between at least a potential buyer of a property and a potential seller of said property, the method comprising:

a) receiving input from said potential buyer, said input being indicative of an interest of said potential buyer in said property;

b) determining a location of said property based on said input from said potential buyer;

c) determining if said property has an entry in a property database;

d) in the event said property has an entry in said property database, determining said potential seller for said property;

e) in the event said property does not have an entry in said property database, creating an entry for said property in said property database and determining said potential seller for said property, said entry in said property database being based partially on said location of said property;

f) initiating contact with said potential seller and providing said potential seller with indicia that provides said potential seller access to a communications channel with said potential buyer;

wherein step f) further comprises providing said potential seller with an identity of said potential buyer.

In a fifth aspect, the present invention provides a method for facilitating contact between at least a potential buyer of a property and a potential seller of said property, the method comprising:

a) receiving input from said potential buyer, said input being indicative of an interest of said potential buyer in said property;

b) determining a location of said property based on said input from said potential buyer;

c) determining if said property has an entry in a property database;

d) in the event said property has an entry in said property database, determining said potential seller for said property;

e) in the event said property does not have an entry in said property database, creating an entry for said property in said property database and determining said potential seller for said property, said entry in said property database being based partially on said location of said property;

f) initiating contact with said potential seller and providing said potential seller with indicia that provides said potential seller access to a communications channel with said potential buyer;

wherein step f) further comprises ensuring that an identity of said potential buyer is not revealed to said potential seller while initiating contact between said potential seller and said potential buyer.

In a sixth aspect, the present invention provides a method for facilitating contact between at least a potential buyer of a property and a potential seller of said property, the method comprising:

a) receiving input from said potential buyer, said input being indicative of an interest of said potential buyer in said property;

b) determining a location of said property based on said input from said potential buyer;

c) determining if said property has an entry in a property database;

d) in the event said property has an entry in said property database, determining said potential seller for said property;

e) in the event said property does not have an entry in said property database, creating an entry for said property in said property database and determining said potential seller for said property, said entry in said property database being based partially on said location of said property;

f) initiating contact with said potential seller and providing said potential seller with indicia that provides said potential seller access to a communications channel with said potential buyer;

wherein said potential buyer is provided with an option to remain anonymous to said potential seller until said potential buyer indicates a desire to reveal an identity to said potential seller.

In a seventh aspect, the present invention provides method for generating recommended properties for a user based on said user's preferences, the method comprising:

a) receiving input from said user indicating an interest in said a selected property;

b) extracting parameters for said selected property and determining user preferences for properties based on said parameters;

c) determining properties that correspond to said user preferences; and

d) providing data for said properties determined in step c) to said user.

In an eighth aspect, the present invention provides a method for generating recommended properties for a user based on said user's preferences, the method comprising:

a) receiving input from said user indicating an interest in said a selected property;

b) extracting parameters for said selected property and determining user preferences for properties based on said parameters;

c) determining properties that correspond to said user preferences;

d) providing data for said properties determined in step c) to said user; and

e) receiving input from said user for each of said properties determined in step c) indicating an acceptance or a rejection of said property as a recommendation.

In a ninth aspect, the present invention provides a method for facilitating contact between real estate professional and a potential seller of a property, the method comprising:

a) receiving input from said real estate professional, said input being indicative of an interest of said real estate professional in said property;

b) determining a location of said property based on said input from said real estate professional;

c) determining if said property has an entry in a property database;

d) in the event said property has an entry in said property database, determining said potential seller for said property;

e) in the event said property does not have an entry in said property database, creating an entry for said property in said property database and determining said potential seller for said property, said entry in said property database being based partially on said location of said property;

f) initiating contact with said potential seller and providing said potential seller with indicia that provides said potential seller access to a communications channel with said real estate professional.

In a tenth aspect, the present invention provides a method for generating recommended properties for a client based on said client's preferences, the method comprising:

a) receiving input from said real estate professional on behalf of said client, said input indicating an interest in said a selected property;

b) extracting parameters for said selected property and determining user preferences for said client for properties based on said parameters;

c) determining properties that correspond to said user preferences; and

d) providing data for said properties determined in step c) to said real estate professional.

In an eleventh aspect, the present invention provides a method for monitoring a selected property, the method comprising:

a) receiving input from a user indicating an interest in said selected property;

b) determining a location of said selected property based on said input from said user;

c) determining if said selected property has an entry in a property database;

d) in the event said property does not have an entry in said property database, creating an entry for said property in said property database, said entry in said property database being based partially on said location of said property;

e) tracking developments relating to said selected property;

f) reporting said developments relating to said selected property to said user;

wherein said user is a potential seller of said selected property.

In a twelfth aspect, the present invention provides a method for facilitating contact between at least a potential buyer of a property and a potential seller of said property, the method comprising:

a) receiving input from said potential buyer, said input being indicative of an interest of said potential buyer in said property;

b) determining a location of said property based on said input from said potential buyer;

c) determining if an electronic mailbox in a system executing said method has been claimed by said potential seller of said property;

d) in the event said electronic mailbox has been claimed, updating an entry for said property in a property database to indicate said interest in said property by said potential buyer; property has an entry in said property database, determining said potential seller for said property;

e) in the event said electronic mailbox for said property has not been claimed, creating an entry for said property in said property database and determining said potential seller for said property, said entry in said property database being based partially on said location of said property;

f) initiating contact with said potential seller and providing said potential seller with indicia that provides said potential seller access to a communications channel with said potential buyer;

wherein access to said communications channel by said potential seller also includes access by said potential seller to said electronic mailbox for said property.

In a thirteenth aspect, the present invention provides a method for monitoring a selected property, the method comprising:

a) receiving input from a user indicating an interest in said selected property;

b) determining a location of said selected property based on said input from said user;

c) tracking developments relating to said selected property;

f) reporting said developments relating to said selected property to said user.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention;

FIG. 2 is a block diagram of the system of the present invention as used in conjunction with external databases and multiple user devices;

FIG. 3 is a diagram of a user interface for entering a potential buyer's self-written profile for sharing with potential sellers;

FIG. 4 is a diagram of a user interface through which a potential seller can enter a code for accessing a communications channel with a potential buyer;

FIG. 5 is a user interface/GUI illustrating the various options for one implementation of the present invention;

FIG. 6 is a user interface for confirming a user photo of a selected property;

FIG. 7 is a user interface for a map interface where a user can enter an address for a selected property;

FIG. 8 is a user interface detailing multiple selected properties for a user and including a status for the transactions for each of the selected properties;

FIG. 9 is a user interface for presenting a potential buyer's self-written profile to a potential seller;

FIG. 10 is a generic mailer generated by the system and for provision to an unknown potential seller;

FIG. 11 is a detailed letter generated by the system for provision to a known potential seller and detailing a code for accessing a dedicated communications channel between the potential seller and a potential buyer;

FIG. 12 is a flowchart for a method according to one aspect of the present invention;

FIG. 13 is a flowchart detailing a further method according to yet another aspect of the present invention; and

FIG. 14 is a flowchart for a third method according to a further aspect of the present invention.

### DETAILED DESCRIPTION

According to one aspect of the present invention, a system is provided for facilitating interactions between potential buyers of a property and potential sellers of that same property. The system works by allowing a potential buyer to designate a property in which the potential buyer has an interest in. The system then determines the owners and/or potential sellers of the designated property that may not yet be listed/for sale. Once determined, the system sends a message to the potential seller indicating the potential buyer's interest in the property. Along with the potential buyer's interest in the property, the message to the potential seller includes some means by which the potential seller can contact the potential buyer. In one implementation of the system, the means is a code by which the potential seller can access a communications channel through the system. This communications channel is exclusively for the use of the potential seller and the potential buyer for conversations about the property. If the potential seller is willing to entertain the possibility of selling the property, the potential seller can use the means to contact the potential buyer and to then discuss the property. If an agreement for the potential seller to sell the property to the potential buyer is reached, one option is for the system to recommend professionals who can provide services relating to the buying and selling of that specific property.

As enhancements to the system, the system may also operate as a means for a user to track and/or be updated as to developments regarding a selected property. The system accesses multiple databases to track whether the selected property has been listed for sale, rent, or lease. In addition, the system can provide updates as to events that may affect the price of the selected property such as zoning changes and unforeseen events including fires, crime, or other events in the area near the selected property. Once a development has occurred, the system can sent notifications to user(s) who are tracking the selected property.

In another aspect of the present invention, the system can also provide estimates of the value of the selected property. As noted above, the system can access multiple databases that may be mined for data, including data relating to previous sale prices or valuations of the selected property. Not only that, but the system can also provide updates as to the estimate or valuation of the selected property based on sales of similar properties near the selected property. These updates as to the estimate or value of the property can also be sent to users by way of notifications. In addition to the estimates or values of the property, the system may also determine other data points such as sales values in areas surrounding the selected property, the number of active real estate buyers and sellers in an area, and perhaps a number of potential buyers that the system has matched with the property based on the preferences of those potential buyers. These and other data points relevant to the selected property or to the value or perceived value of the selected property can be sent to the users (i.e. including not necessarily potential buyers or potential sellers) who are tracking the selected property.

The system can also provide recommendations for users or to potential buyers and other users based on preferences input into the system for potential buyers or on behalf of potential buyers or preferences that the system determines based on the selected properties selected by potential buyers or selected on behalf of potential buyers.

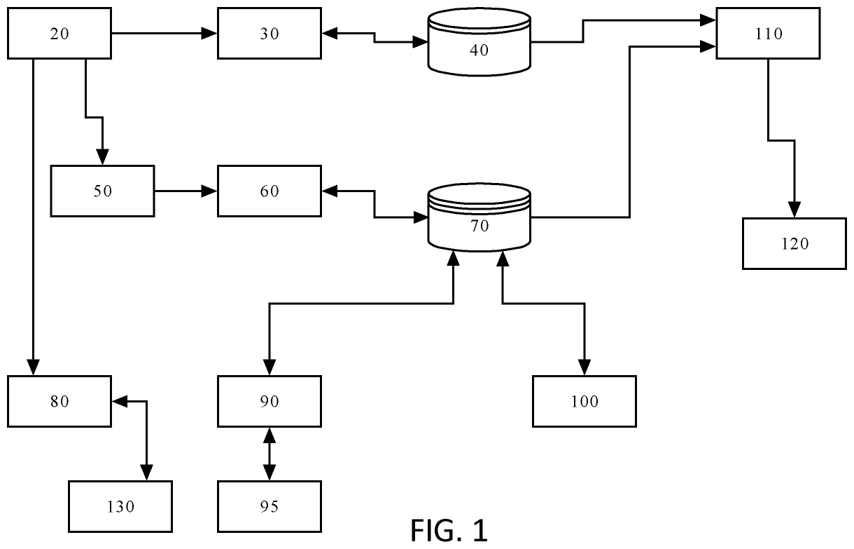

Referring to FIG. 1, a block diagram of a system according to one aspect of the present invention is illustrated. As can be seen, system 10 includes an input module 20, a user database management module 30, and a user database 40. AS well, the system 10 includes a locator module 50, a property database management module 60, and a property database 70. A communications module 80 is also present along with a recommendation module 90. A tracking module 100 is also present along with a contact module 110. In one variant, an email module 130 communicates with and is used by the communications module 80. The email module 130 may contain its own database for messages and emails between users.

Regarding the functions of the various modules, the input module 20 receives input from users and, where necessary, formats or adjusts the input to a suitable form for the system. As an example, free form input (e.g. user entered addresses) can be formatted so that the system can properly search for the addresses. As another example, photos of the property can also be formatted to a suitable pixel size and, if necessary, resolution. The input module can also determine if the user input is suitable or not and can continue to ask for a proper input if such is not detected. For example, when receiving a new username for a new user, if the entered username is too short, too long, or has already been used, the input module can continue prompting the new user for a suitable username that meets the desired criteria.

Once a new user has entered a suitable username, the user's new credentials are then passed by the input module 20 to the user database management module 30. The user database management module 30 then formats a suitable new entry for the user database 40. The new user entry can then be stored in the user database and can be linked to any property that the user has selected, and which already exists in the property database 70. Of course, if the new user has selected a property that is not in the property database 70, this new property would be catalogued and entered in the property database 70 as explained below. The user database management module 30 deals with not just the addition and deletion of user entries in the user database but also with the editing of the content in the various user entries. As an example, changes to a user's name, address, email address, password, and user settings would be attended to by the user database management module 30.

As noted above, the user database 40 contains the entries for the various users of the system. These users may be potential buyers, property owners/potential sellers, professionals involved in real estate transactions, other real estate related professionals or any other entity who may be interested in a real estate property. It should be clear that, depending on the configuration of the system, a user may be assigned one or more roles or categories, or each user may be tagged one or more tags defining their role. The database entry for each user may include the user's name, address, email address, contact information, job title/description, profile information, a short user created profile (which may be provided to potential sellers), user system preferences (i.e. user system settings), property preferences, properties currently selected by the user, properties selected by the user in the past, statistics regarding the user's use of the system (e.g. how long has the user been in the system, how often do they login, any transactions the user has participated in, etc.), as well as any other data points that may be useful in providing a suitable real estate related service to the user.

To denote a selected property, a user may enter the property's address, or the user may take a digital photo of the property or a screen shot of a mapping application/database (e.g. Google Maps™ or Apple Maps™). The digital photo is then uploaded to the system and the system can try and locate the physical address of the selected property. With the user's location (determined either through their mobile device or entered by the user), the locator module 50 can be used to determine the selected property's address. The locator module 50 can attempt to determine the selected property's address by determining the area of the user's location (or the user's actual location from the user's GPS coordinates) and then attempt to match the user's uploaded photo of the selected property with street photos of the area from well-known mapping databases and services such as Google Maps™. The locator module 50, if it finds a suitable potential match, can then provide the address of the potential match to the user, potentially using a GUI to show the marker of the potential match on a suitable map. The user can then confirm the address of the selected property or the user can correct the address by entering the correct address (e.g. using a text box) or the user can use a GUI to move the marker to the correct address. Of course, if the user simply enters the address of the selected property, then the locator module 50 simply has to locate the address on the GUI map and provide the map (with the suitable marker) to the user for confirmation. Once the locator module 50 determines the selected property's address, this can be sent to the property database management module 60.

Once the selected property's address has been determined, then the property database management module 60 creates a suitable property database entry for that property. Of course, if there is already a suitable property database entry for that selected property, a duplicate entry is not created. The property database management module 60 can then populate the property database entry with the data needed such as the property's GPS coordinates, the address, city, etc., etc. The entry can then be stored in the property database 70. As can be imagined, the property database management module 60 manages the entries in the property database 70. This includes the addition, deletion, and/or editing of the entries in this database.

The property database 70 stores the database entries for each of the properties that have been selected by the users. Each property's database entry can include not just the address of the property but also the property's GPS coordinates but also whatever data has been gathered about that property, including the property's current owner, the property's past owners, the sale prices of the property when it had been sold in the past, estimates of the property's current value, current and past valuations of the property, past and present property taxes for the property, construction/repair history of the property, past and current indications of interest in the property, past and present indications of interest in similar properties in the same area, past listing agents for the property, current and past mortgages on the property, any liens on the property, the physical data about the property (e.g. number of rooms, number of bathrooms, size of each room, layout plans for the property, etc.), as well as any other data that may be useful in determining the history of the property and the value of the property. In addition, the entry may also contain an indication or a capability to search for system users who are currently interested in properties within the same area. The database entry for each property can have similar data as a real estate property listing but would also have more data than such a listing, including the history of the property. In addition, each property's database entry can list the users who have shown an interest in the property in the past.

To facilitate contact and interaction between potential buyers and potential sellers of one or more properties (or between any two users of the system), the system includes a communications module 80. The communications module 80 can be used to provide a venue or a means through which the two parties (e.g. the potential buyer and the potential seller) can communicate with each other. The module 80 may thus provide an email system (with suitable email addresses for the participants and accessed or implemented through the email module 120) through which the potential buyer and the potential seller (or any two users) can communicate by exchanging emails. The emails exchanged need not reside on the system as these can be forwarded to each user's personal/professional email account. Depending on the configuration and settings of the system, emails exchanged can be anonymized so that each user using the email system need not disclose their name or contact information to the other party. Such anonymity can, of course, be of use in the opening stages of negotiations between potential buyers and potential sellers when each party simply gauges the other party's interest and/or suitability for a transaction. Once each party is satisfied that a transaction is possible, then less anonymity may be desired and other communications means may be employed. It should be clear that the email subsystem of the system 10 may be configured to provide an email address or an email communications system to all users of the system. In one implementation, the email system can be configured to provide an electronic mailbox (to store/receive emails and/or other messages) for each property. A potential seller can, by logging into the system, claim the electronic mailbox for that property, perhaps in addition to his or her own electronic mailbox in the system. Each property's mailbox can be used as the repository of messages from potential buyers who are showing interest in the property. Thus, instead of sending a code for a communications channel to the potential seller, the potential seller may be directed to the website for the system and to claim the property's associated electronic mailbox. The property's electronic mailbox and the system's email system can thus form the communications channel by which the potential seller and the potential buyer can communicate with each other. The claiming of the property's electronic mailbox can take the place of the entering of the code to access the system's communication system. By claiming the property's designated electronic mailbox, the potential seller can use the system and/or be registered into the user and property databases.

To farther facilitate the interactions between the potential seller and the potential buyer, the communications module 80 may implement a real-time chat client that provides a private communications channel between the two parties. Once initial contact between the two parties has been established, the parties can agree on a time when both will be online, and both can use the online chat system to discuss the selected property. Since the selected property is, in one configuration, not yet listed (i.e. not yet officially for sale), each party can, using the chat client, gauge each other's readiness/suitability for a possible transaction. The real-time chat client can be used in conjunction with an email system as explained above so that, instead of setting a time for a conversation between the two parties, emails may first be exchanged between the two.

In another implementation, the communications module 80 establishes a VoIP voice channel for the potential buyer and the potential seller without divulging each other's identities or contact information. Similarly, the communications module 80 may establish a text or SMS based communications channel between the two parties without divulging each other's identity or contact information. As an example, each party can be given a number to which SMS messages can be sent. The system then receives these SMS messages, strips out any identifying information from the SMS message (e.g. the originating telephone number), adds its own headers, and forwards the new message to the other party. This way, any SMS messages are anonymized as the system acts as a go-between between the two parties. Finally, a video-based communications channel may also be implemented by the communications channel 80 between the two parties. Of course, such a video-based channel may not be used until each party is comfortable with proceeding further with negotiations as the video-based communications channel would reveal each party's identity.

A recommendation module 90 is also part of the system 10. The recommendation module 90 mines each user's profile/database entry and each user's usage history to determine that user's preferences as applied to properties. Then, the recommendation module 90 uses those preferences to search the property database (or another database) to find properties that match those user property preferences. Accordingly, the recommendation module 90 finds each user's desires or preferences for a property. This can include price range, number of rooms, desired area, amenities nearby, along with other preferences that may not be readily apparent or that may not have been explicitly noted by the user. These preferences are then used to perform a search for properties that conform to these preferences or at least conform to most of these preferences, regardless of whether the property is currently listed as being for sale or not. The resulting list of properties can then be presented to the user as recommendations. Where available, the recommended properties can be presented to the user with photographs, statistics about the recommended properties, as well as most if not all data available to the system about such recommended properties.

To accomplish the above recommendations, the recommendation module 90 may include a sub-module 95 that uses artificial intelligence and/or machine teaming and that accesses the user database. A user's profile, as well as any history of the user's usage of the system (including selected properties, cached or stored messages, and any other data available to the system) is searched and data regarding preferences are retrieved from the user database. The user's data can then form the training set for a machine learning subsystem with the desired results being the user's selected properties. By adjusting the weights in a neural network that is trained using this data (with the user's selected properties as the desired results), a neural network that selects properties based on the user's preferences can be obtained. The resulting neural network can then be used to filter the various properties in the property database so that the end result of the filtering is a list of properties that most conform to the user's preferences. It should be clear that the data filtered through the resulting trained neural network may include property data culled or retrieved from other databases including databases that have listings of available properties for sale. As well, the data filtered may include data retrieved from other general databases that contain data about properties that are both for sale and not currently for sale. In one aspect, the resulting list of recommended properties may be only properties that are currently for sale. In another aspect, the resulting list of recommended properties includes properties that are currently not for sale. In yet a further aspect, the list of recommended properties may include both listed (currently for sale) and unlisted (currently not for sale) properties.

It should be noted that the recommendation module 90 may also be used to make recommendations based on user entered inputs. A user may, in one aspect of the invention, select an option such that the system seeks properties and makes recommendations based on what the user has entered instead of what the user may have selected in the past. The user can then enter desired parameters for the property sought including price range, location (i.e. area/neighborhood), number of rooms, number of bathrooms, amenities nearby, public transportation available, etc., etc. It should be noted that, for this option, the AI/machine teaming sub-module may not be necessary as the parameters need not be extracted from disparate data sources. However, of course, depending on the implementation of the system, this sub-module may still be employed to select outlier properties that may not be selected in a simple parameter-based search. Of course, depending on the implementation, the AI/machine teaming sub-module may still be used for searching other databases for properties and/or data regarding properties.

It should be clear that, in another aspect of the present invention, the system 10 is used by a real estate professional to generate recommendations for one or more clients. The real estate professional would enter a client's preferences regarding properties (e.g. preferred area, number of bedrooms, price range, lot size, etc., etc.) and then the system would generate recommended properties as outlined above. Alternatively, the real estate professional can designate a representative property as a client's preferred or selected property and the system can generate recommendations based on that selected property. The real estate professional can then provide the recommendations to his or her client.

Another module that is part of the system is the tracking module 100. The tracking module 100 accesses multiple databases external to the system and gathers data regarding a selected property. Such data gathered can then be brought to the attention of one or more users who have indicated an interest in that selected property. This data can include events that may affect a property's value (e.g. crime/fire/disasters near the property's location or in the property's area), listings of the property as being for sale or rent, listings (with asking prices) of similar properties in the area or near the selected property's location, current and past valuations of the selected property, completed sales of similar properties (with final prices) in the area or near the selected property's location, property tax assessments for the selected property, zoning changes, services that are new to a property's area (e.g. a light rail coming on line), and other data that may relate to the selected property. It should be clear that the various databases accessed by the tracking module 100 may include databases that have real estate listings, completed real estate listings, property tax assessments, municipal tax assessments, rental listings, and general news databases. Such general news databases may include databases for national, regional, and local news sources. Databases for government based data (e.g. tax assessments) may include government (e.g. federal, municipal, state, provincial) databases. These databases accessed may include databases where fees are charged for access as well as databases which may be accessed for free.

It should be clear that a user may be interested in multiple selected properties and may track each and every one of these selected properties separately. Preferably, each selected property is represented by an entry in the property database and that each piece of data gathered for a property by the tracking module 100 is stored and properly indexed in the property database. As such, each property entry in the property database not only includes data about the property's physical attributes (size, location, address, layout, etc.) but also data regarding the property's valuation (e.g. current and past estimated values, previous final selling price, assessed value for tax purposes, etc.) and also events that may affect the property's value/well-being (e.g. crime statistics for the area, disasters/events nearby, etc.). It should also be clear that users using the system to simply track different properties need not be potential buyers or potential sellers. Other users, such as real estate professionals, may use the system to track various properties. Different users may also not necessarily be on the market to purchase properties but may simply be performing research and may require the tracking of various properties. That being said, a property owner may wish to track or follow his or her own property through the system to determine the property's current and past value or for other purposes.

A contact module 110 is also present in the system 10. The contact module 110 is triggered by the input module 20 whenever a new selected property is selected or tagged by a user (new or existing user). Once activated, the contact module 110 then receives the details about the new selected property from the property database 70, including the contact information for the potential seller of the new selected property. This contact information may be the potential seller's email address, physical address, social media contact information, or any other address or contact information that can be used to contact the potential seller.

Regarding user privacy, the system may be configured to keep identities confidential until a user indicates otherwise. Thus, a potential buyer may be placed in contact with a potential seller with both parties being kept anonymous to one another. Or, alternatively, the system may be configured such that a potential buyer's identity is revealed to the potential seller when the potential seller is initially contacted, perhaps through an email or a mailer. Or, in yet another alternative, the system may only reveal a user's identity to another party prior to the two users contacting each other through the communications module. A further variant would have the potential buyer's identity kept from the potential seller until the potential buyer indicates to the system that his or her identity may be revealed.

It should be clear that such contact information may be culled from various sources such as real estate listing databases (e.g. databases that list previous transactions so that the last purchaser of the selected property can be found), telephone book-based databases, and automated Internet-search based search results.

Once the potential seller has been identified (and the identity of the potential seller has been entered in the property database as being associated with the selected property) and the potential seller's contact information has been found, the contact module 110 can prepare a suitable communication 130 for the potential seller. This communication, based on the various possible configurations of the system, may be an email, a private message on social media, a text message, or a physical letter printed as a mailer. Any form of electronic communication and any form of paper or physical form based communication may be used to contact the potential seller. For an implementation involving a physical communications medium (e.g. a letter or mailer being sent to a potential seller), the letter or mailer may be sent by courier requiring a signature receipt or the mailer or letter may be delivered to the potential seller in person by way of a designated representative. The communication, preferably, would indicate that a potential buyer (who may be named or unnamed depending on the configuration of the system) has shown interest in the selected property and would like to discuss the matter with the potential seller. Optionally, the potential buyer's self-written profile or the potential buyer's “story” (i.e. background, length of search for a suitable property, etc.) can be included in the communication. In a further variant, the communication may contain a conditional offer on the property.

It should be clear that the communication may include any number of data points that may assist the potential seller in determining whether to proceed further with the matter or not. In one example, the communication may include a rating for the potential buyer with an explanation that the rating indicates the potential buyer's financial/reputational worthiness to purchase the property. Similarly, the communication may include the potential buyer's qualification (e.g. financial stability/history of transactions) that would indicate the potential buyer's suitability as a purchaser for the property. These qualifications may include being pre-qualified for loans and/or mortgages, that the potential buyer is working with a real estate professional, or that the potential buyer is set to buy a property within a given period of time.

It should be clear that the communication would include a means by which the potential seller can contact the potential buyer through the system 10. Such means by which the potential seller can contact the potential buyer may include a code that, when the potential seller enters the code into the system, gives the potential seller access to a one-on-one communications channel. This communications channel is between the potential seller and the potential buyer by way of the communications module 80. As such, should the potential seller be interested in pursuing the matter, the potential seller would need to create an account on the system 10 and enter the provided code in the communication. The code would give the potential seller direct access to the communications channel (e.g. an online chat, an email account, etc.) with the potential buyer. Once the code has been activated on the system by the potential seller, the potential buyer is then notified with another suitable code that, when entered into the system, provides the potential buyer with direct access to the same communications channel. Once both the potential seller and the potential buyer have both activated their codes and have access to the communications channel, these two parties can discuss the selected property to determine if there is any interest or possibility of exploring a sale, rental, or lease of the selected property. In another variant, the potential buyer would not be required to enter his or her own code as the potential seller's activation of his or her account may trigger a message to the potential buyer that contact and communications with the potential buyer may commence.

It should be clear that if the potential seller and the potential buyer are amenable to pursue the matter further, the system may be triggered to provide suitable recommendations for professionals who may assist the two parties regarding the selected property. Such professionals, including real estate lawyers, real estate agents, and the like, may also be registered users of the system 10. The system 10 can separately query the potential seller and the potential buyer as to the qualities that each is looking for in a professional that can assist them in the transaction. Based on the results of the query, the system can search the user database for suitable candidates for each party and can provide each party with a list of candidates. The parties can then select from their own lists and the system can attend to contacting the selected professionals as necessary.

While the above description is directed to the use of the system by a potential buyer to select properties that the potential buyer may be interested in, the system can also be used by real estate professionals (e.g. realtors). Such professionals may use the system on behalf of clients who are seeking properties or the professionals may use the system to determine if a potential seller of an unlisted property may be ready to consider selling the property. Thus, for a real estate professional to use the system as a user, this user would input the client's preferences (e.g. location, number of rooms, price range, etc., etc.) as necessary or this user may indicate interest in a selected property on behalf of a client. For such a use, the potential seller, if the potential seller is interested in pursuing the matter, would be placed in touch with the real estate professional by way of the communications module as explained above. Alternatively, the user may be an employee or an agent of a real estate brokerage seeking to gauge a potential seller's interest in selling his or her property. The system and method of the present invention would proceed as explained and described but with the brokerage and/or its agents taking the place of the potential buyer.

In one implementation of the system 10, the system 10 takes the form of an app or application that can be installed on a smartphone and may be accessible by way of a suitable web browser on a data processing device (e.g. desktop computer, tablet computer, laptop, smartphone, etc.). In the smartphone app implementation, the user can use the smartphone's camera to take a photo of a selected property and can use the smartphone's GPS capabilities to indicate the location or at least the area where the selected property is located. The user's inputs into the smartphone app implementation of the present invention can then be uploaded to the server implementing the system 10 and the system 10 can then proceed to execute its various module as explained above. For a desktop/laptop implementation, the system 10 may be integrated with a suitable mapping application/service that allows a user to enter an address, a cross-street, or a general area/location. The user is then provided with a map and/or a photograph of the selected address/area. The user can then adjust the specific address denoted by the user interface to show a picture and/or map location of the selected property. Once the selected property has been suitably indicated to the mapping application/service integrated into the system 10, the user can indicate that the selected property has been selected. The system can then proceed as explained above.

To allow the user ease of access to the system, a suitable menu/GUI subsystem may be employed. Such a menu/GUI would allow a user access to not just a listing of the user's selected properties but also to the various communications channels that may be active with multiple other users. Of course, these multiple other users may be potential sellers or potential buyers as the case may be. Similarly, the menu/GUI system should also provide each user with access to the various data points gathered for each selected property. At a glance, each selected property can be scanned so that the user can view the property's sale history, the property's price history, events in the area, and other data points gathered for that particular selected property. In addition to the above, the menu/GUI system may be configured to provide the user with a listing of the recommended properties based on the user's preferences, either as explicitly entered by the user or as extracted by the system from the user's data as explained above. Preferably, each recommended property may be activated or selected by the user and, once activated, the details regarding the recommended property can be provided to the user.

One embodiment of the invention may involve the selection and/or activation of a recommended property as provided by the system. The user may be provided with a list of recommended properties or the user may be provided with details regarding each recommended property. Each recommended property can also be detailed on a single user interface (i.e. one screen) and the user can simply interact with the user interface to indicate an interest or lack of interest in the recommended property. For a user interface that is implemented by way of a touch screen interface, the user may simply “swipe” towards a specific direction to indicate interest and “swipe” in another direction to indicate a lack of interest in the recommended property. Thus, a user may swipe up to indicate that the user wishes to review this property further or the user may swipe down to indicate that the user does not wish to review the property further. Of course, the direction of the swipe and how such an interface is used is dependent on the implementation (e.g. swipe left instead of swipe up and swipe right instead of swipe down).

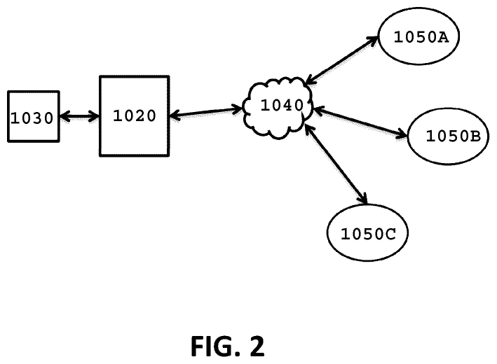

It should be clear that the system of the invention may be used in myriad manners by different users. To explain one implementation, FIG. 2 is provided. As can be seen, one implementation of the invention uses a system 1020 communicating with external databases 1030. The system 1020 communicates with various users on various devices 1050A, 1050B, 1050C by way of network 1040. As can be imagined, the network 1040 can be the Internet while the various devices 1050A, 1050B, 1050C can be mobile devices, desktop computers, or other suitable data processing devices.

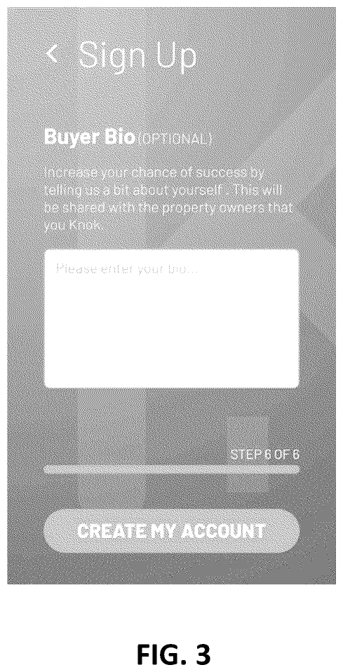

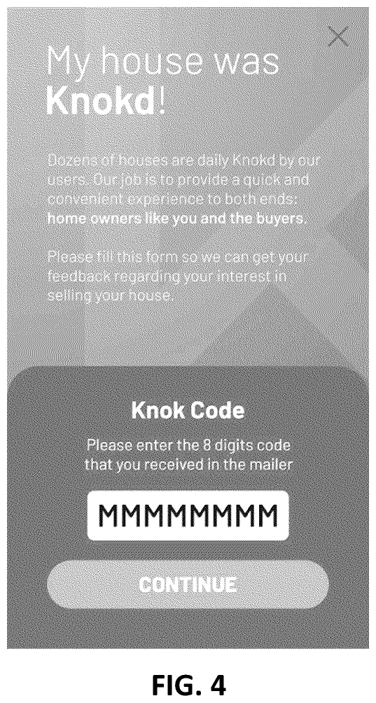

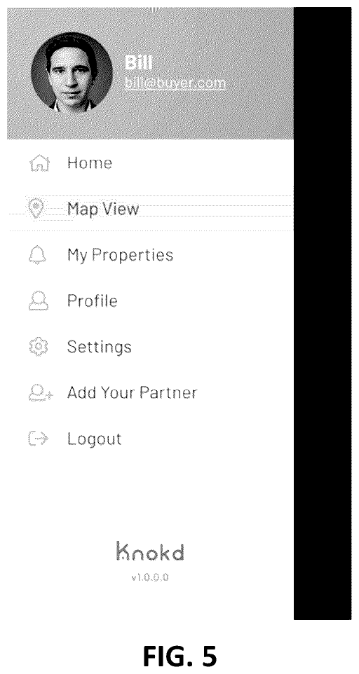

Referring to FIG. 3, as noted above, a user may enter a self-written profile or story that can be shared with potential sellers. FIG. 3 shows the user interface that may be used to elicit such a self-written profile from a new user registering for the system 10. Referring to FIG. 4, a user interface that may be used to enter a code as explained above is provided. As noted above, the code would be used by a potential seller to unlock a communications channel between the potential seller and a potential buyer. FIG. 4 shows that the potential seller has received a mailer containing an 8-digit code that, when entered, can place the potential seller with the potential buyer that has expressed interest in the selected property. Regarding the user interface/menu for the user of the system, FIG. 5 illustrates one possible menu/user interface. As can be seen, in this implementation of the menu, a map view option is provided along with the properties associated with the specific user's profile.

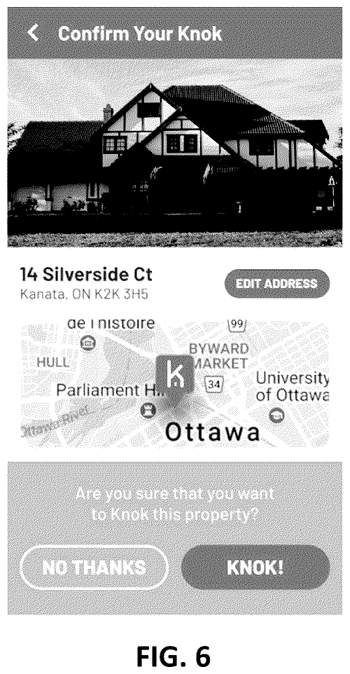

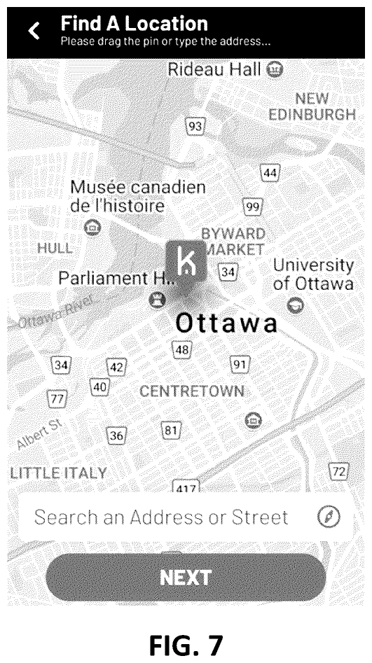

When in use, the system confirms each user's selected property. Referring to FIG. 6, a user interface confirming a user's photograph of a selected property is illustrated. As can be seen, for FIG. 6, the system has already determined the location of the selected property and is merely confirming this address. Of course, the user can adjust the address as necessary. FIG. 7, conversely, illustrates a user interface that uses a mapping system/service that allows the user to simply enter an address for the selected property.

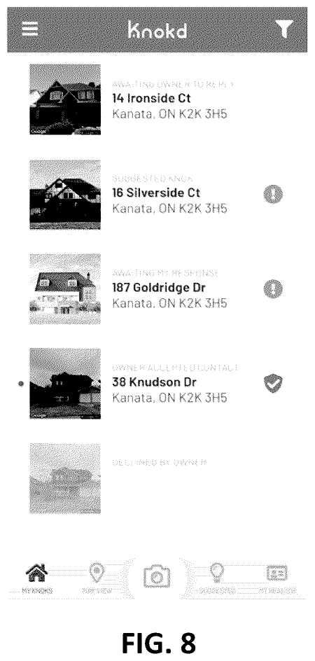

Referring to FIG. 8, the user interface that illustrates the various selected properties that the user is interested in is illustrated. As can be seen, each selected property has a status that indicates the status of the communications between the potential buyer and the potential seller. The topmost selected property query is awaiting a response from the potential seller while the bottommost selected property query has been rejected by the potential seller. The query for the property that is third from the top indicates that communications are ongoing with the potential seller and that the potential buyer has to respond to a communication. The query for the property that is fourth from the top has had the potential seller accept the communications channel but that communications has not yet started. The second property is a recommended property based on the user's preferences.

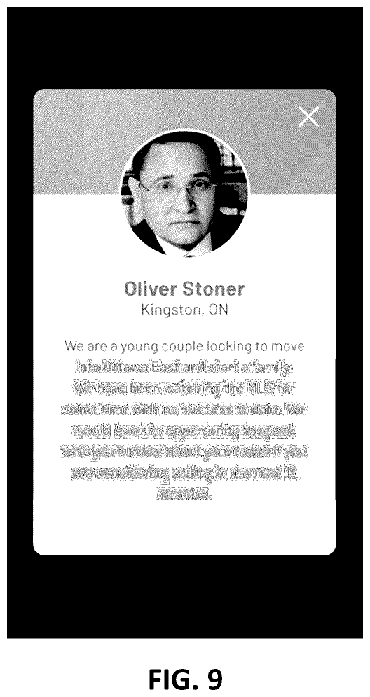

Referring to FIG. 9, illustrated is a user interface showing a profile for a potential buyer. Such a profile may be provided to a potential seller should the potential seller show potential interest in the sale/rental/lease of the selected property.

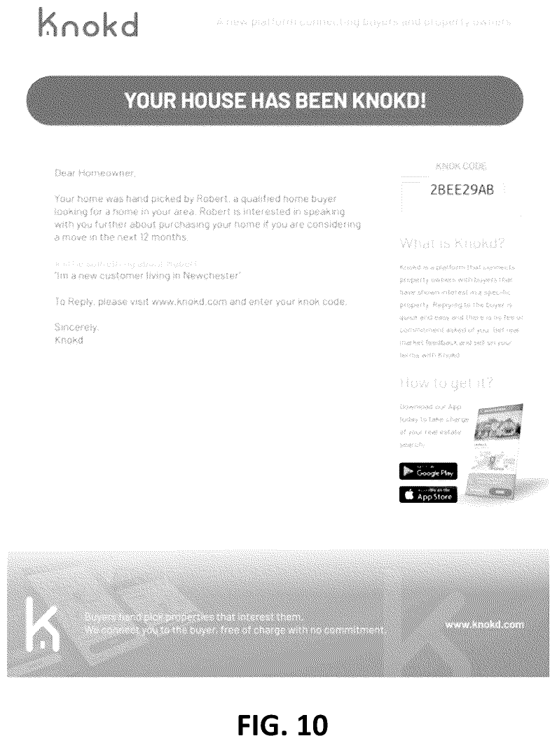

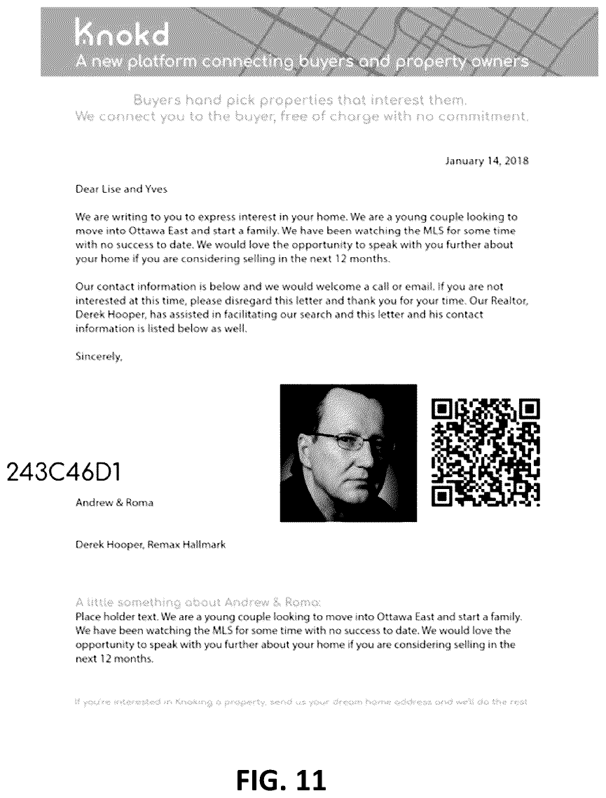

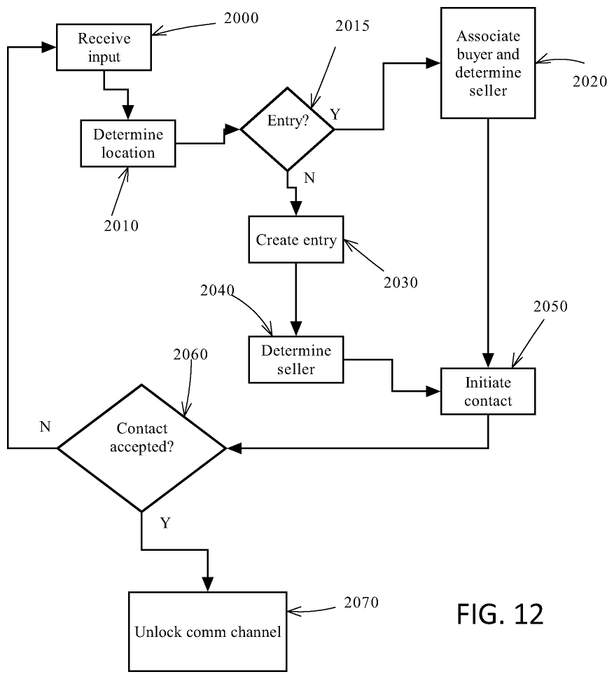

Referring to FIGS. 10-11, illustrated are various implementations of communications from the system to potential sellers indicating that a potential buyer has expressed interest in the selected property. FIG. 10 illustrates a brochure that may be sent to a generic potential seller including a code for use in accessing a communications channel with a potential buyer. Similarly, FIG. 11 illustrates a letter to a specific potential seller from the system as used by a specific real estate professional to gauge interest in selling a selected property for a specific potential buyer. As can be seen, FIG. 11 includes a code that may be used to access the communications channel as well as a QR code that may be used to access the website for the system. FIG. 12 shows a generic mailer for use when a specific potential seller cannot be located. Such a mailer can be dropped at the selected property to determine if the owners or the occupants would have an interest in selling the property. As can be seen, the specific code for accessing the communications channel is included in the mailer.

It should be clear that the system of the present invention is eminently suitable for initiating communications between potential sellers and potential buyers of a property. However, it can also be used by potential sellers to determine the current status/value of his or her property. Thus, a potential seller (e.g. a property owner) can use the system to determine the history of the property, the current and past valuations of the property, and to gauge any interest in the property.

In addition to the above, real estate professionals may also use the system to search for properties for clients who are interested in a specific area. Real estate professionals can select one or more properties to gauge interest by potential sellers about selling their property. Or, of course, the real estate professional may recommend that a potential buyer use the system to approach a potential seller for a property that is not yet for sale.

Referring to FIG. 12, a block diagram of a method according to one aspect of the present invention is illustrated. The method begins at step 2000, that of receiving an input from a potential buyer with the input indicating a selected property. The system then determines the location of the selected property (step 2010). If the property has an entry in a property database (decision 2015) then the potential buyer is associated with the selected property and the potential seller for the property is determined (step 2020). On the other hand, if the selected property does not have an entry, a suitable entry for the property database is created (step 2030) and the potential seller for that property is determined (step 2040). Once the potential seller for the property has been determined, then contact is initiated with that potential seller (step 2050). This contact may be by way of a mailer, an email, or any suitable means of contacting the potential seller as explained above. If the potential seller does not accept the contact (decision 2060), then the logic loops back to the beginning of the process. On the other hand, if the potential seller accepts the contact and accesses the system, then the system unlocks a dedicated communications channel between the potential seller and the potential buyer (step 2070). As noted above, the potential seller may access the system by logging in and claiming an electronic mailbox designated for the selected property instead of entering a code from a mailer.

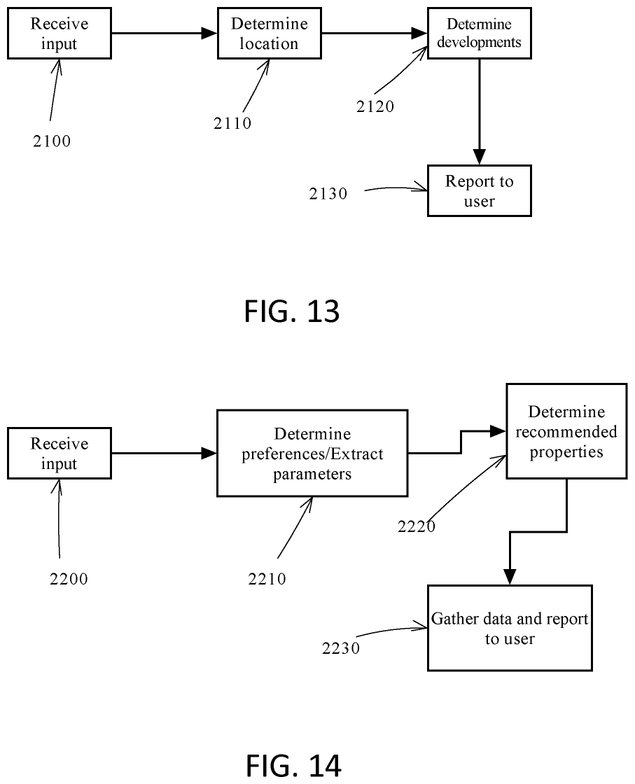

Referring to FIG. 13, a method according to another aspect of the invention is illustrated. In this method, a selected property is monitored using the system as explained above. The process begins at step 2100, that of receiving input from a user. The input is an indication that the user is interested in the selected property. The input is then used to determine the selected property's location (step 2110). Depending on the form and format of the user input, the various methods noted above for determining the selected property's location may be used. In step 2120, developments regarding the selected property are then tracked. This can be done by accessing various both external and internal databases. Multiple types and forms of databases with different contents may be accessed for data relating to the selected property. Once the developments have been determined, the results can be formatted and reported to the user (step 2130). Of course, steps 2120 and 2130 can be looped and continuously executed so that the user and provided with a continuous stream of developments as they arise. As noted above, the method for monitoring selected properties may be practiced using the system of the present invention by multiple individuals and entities such as potential buyers, potential sellers, property owners, banks, realtors, real estate agencies, and by anyone who may have an interest in a selected property.

Referring to FIG. 14, the steps in a method according to another aspect of the present invention is illustrated. In this method, recommendations for properties are generated based on a user's preferences. The method begins at step 2200 where input is received from a user regarding an interest in a property. Step 2210 is that of extracting parameters for the property and determining user preferences based on the parameters. Step 2210 may include mining or analyzing the user's previous interactions with the system (perhaps using the AI/machine learning submodule) to determine further parameters for the user's preferences. Once the user's preferences have been determined (and the determination of the user's preferences may be an iterative process as the user's preferences may evolve overtime), the properties that conform or most conform to the user's preferences are found (step 2220). This may involve accessing multiple databases of both listed and unlisted properties and searching those databases for suitable properties. It should be clear that an exact match to the user's preferences is not necessary to be included in a list of recommended properties—it should be enough that a property is more suitable than others based on the property's conformity to the user's preferences. Once these recommended properties have been determined (by mining their details and comparing these details to the user's preferences), further data regarding the properties may be gathered and provided to the user (step 2230). As can be imagined, the steps in the process can be iterated to provide the user with a continuous list of recommended properties and to adjust/evolve the user's preferences as the user interacts more with the system. As noted above, a further step may be that of receiving a user input that provides an indication of the user's acceptance/rejection of a recommended property. The user input may be a “swipe” on a touch screen interface.

For clarity, the methods in FIGS. 13 and 14 may be executed by any individual or entity on their behalf or on behalf of others. As such, the system that implements the methods may be operated/used by any entity that has an interest in a property or in properties. Thus, a real estate professional may execute the methods (i.e. use the system) on behalf of a client, with the client's preferences being determined/entered into the system. In one variant, a user may be provided with the option of entering data on behalf of another entity and this would configure the system to not mine the user's interactions with the system for the preferences/parameters. The user may be any individual or entity who has an interest in one or more properties and specifically includes real estate professionals, potential buyers, potential sellers, and property owners.

It should be clear that although the above describes a sale of a property, the system and method of the present invention may be used for any transaction between two parties. Thus, the selected property may be sought for a rental, a lease, or any other transaction including a sale. As well, the property being selected is not necessarily real estate. The property may be personal property (i.e. any property that is not real property) and the transaction being sought may not be a sale but may be a rental, a lease, or any other transaction affecting the property. In another variant, the property that may be the subject of the system may be one or more businesses and the potential sellers and/or potential buyers may be other businesses such as investment banks and/or other banking/financial conceals or entities. In a further variant, the property that may be the subject of the system of the invention may be critical parts or supplies necessary to maintain large capital assets such as buildings, vehicles, and/or naval ships.

It should be clear that the term “potential seller” includes owners of a property as well as non-owners but who may have the power to sell or otherwise dispose of the selected property. As such, entities who may own property or who may have the ability to sell/rent or otherwise affect the ownership and/or occupancy and/or use of a selected property is included in the term “potential seller”. As well, the term “potential buyer” includes entities who may have been given charge of a task and entities who may have the ability to bind and/or otherwise represent other entities in one or more property transactions.

It should also be clear that the term “potential buyer” includes any entity that may be interested in a selected property for any reason whatsoever. Thus, a potential buyer may include a person, corporation, or any entity that may be looking to buy, rent, or lease, a property. As well, “potential buyer” may also include any entity that may be interested in tracking a selected property's status and/or value and/or developments regarding such a selected property. Note that “potential buyer” may also include entities that may be pursuing or otherwise executing tasks on behalf of another entity. Thus realtors, lawyers, or other professionals who use the system on behalf of their clients may also be included in the term “potential buyer”.

To assist in the monetization of the system, potential sellers may be charged a fee to access the system and/or be placed in communication with one or more potential buyers. As well, for potential buyers, they may also be charged a fee for use of the system such that there is one payment tier for using the system and there could be another payment tier once a potential seller is in communication with the potential buyer about a selected property. Other users who are merely using the system to track developments regarding specific properties may also be charged service and/or usage fees. Realtors and/or other professionals dealing with the real estate market may also be charged fees for not just use of the system but also for the opportunity to be recommended to users potential buyers and/or potential sellers who have reached agreement about a selected property.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”) or in any other suitable programming language (e.g. “Go”, “Dart”, “Ada”, “Bash”, etc.). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1-125: (canceled)

126: A system for facilitating interactions between at least one potential buyer of at least one property and at least one potential seller of said at least one property, the system comprising:
a user database for storing entries relating to said at least one potential buyer and said at least one potential seller;
a property database for storing entries relating to said at least one property;
a user database management module for managing said entries in said user database;
a property database management module for managing said entries in said property database;
a user database management module for managing said entries in said user database;
a contact module for initiating contact between said at least one potential buyer and said at least one potential seller;
a property location module for determining a location of said at least one property based on input from said at least one potential buyer;
a communications module for providing at least one communications channel between said at least one potential buyer and said at least one potential seller;
wherein at least some of said entries in said property database are based on said location of said at least one property, and
wherein said system enables said at least one potential buyer to indicate an interest in properties that are not currently listed as being for sale.

127: The system according to claim 126, wherein said at least one communications channel is at least one of:
a real-time online chat channel;
an email-based communications channel;
a voice-based communications channel;
a text-based online communications channel; and
a video-based online communications channel.

128: The system according to claim 126, wherein said input from said at least one potential buyer used to determine said at least one property's location is at least one of:
a digital image of said property;
an address of said property;
an address of a general area for said property;
an address of a nearest cross-street to said property; and
a GPS location of said at least one potential buyer when said at least one potential buyer is adjacent said at least one property.

129: The system according to claim 126, wherein said property location module determines said location for said at least one property by providing said at least one potential buyer with at least one test location for said at least one property and receiving further input from said at least one potential buyer that corrects said at least one test location to said location for said at least one property.

130: The system according to claim 126, wherein said contact module provides said at least one potential seller with indicia that provide said at least one potential seller access to a communications channel with said at least one potential buyer.

131: The system according to claim 130, wherein said indicia comprise a code for accessing a website that accesses said communications module.

132: The system according to claim 126, wherein said contact module executes computer-readable and computer-executable code that causes at least one of:
sending an email to said at least one potential seller regarding said at least one potential buyer's interest in said at least one property; and
a printing and a sending of at least one letter to said at least one potential seller, said at least one letter indicating said interest of said at least one potential buyer in said property.

133: The system according to claim 136, further comprising a tracking module for tracking developments relating to said at least one property.

134: The system according to claim 133, wherein said tracking module notifies specific users whenever developments relating to said at least one property occur.

135: The system according to claim 134, wherein said specific users include at least one of: said at least one potential buyer, said at least one potential seller, and professionals involved in sales or transfers of said at least one property.

136: The system according to claim 133, wherein said developments tracked by said tracking module include at least one of:
a listing of said at least one property as being for sale;
a listing of said at least one property as being for rent;
a registration of a mortgage on said at least one property;
a sale of a property near said at least one property;
a rental of a property near said at least one property;
publication of at least one news article regarding an area where said at least one property is located; and
a registration of a lien against said at least one property.

137: A method for monitoring a selected property, the method comprising:
receiving input from a user indicating an interest in said selected property;
determining a location of said selected property based on said input from said user;
determining if said selected property has an entry in a property database;
in the event said selected property does not have an entry in said property database, creating an entry for said selected property in said property database, said entry in said property database being based partially on said location of said selected property;
tracking developments relating to said selected property; and
reporting said developments relating to said selected property to said user,
wherein said method enables said user to indicate said interest when said selected property is unlisted and
wherein said method is implemented using a system comprising:
a user database for storing entries relating to said at least one potential buyer and said at least one potential seller;
said property database, said property database being for storing entries relating to said at least one property;
a user database management module for managing said entries in said user database;
a property database management module for managing said entries in said property database;
a user database management module for managing said entries in said user database;
a contact module for initiating contact between said at least one potential buyer and said at least one potential seller;
a property location module for determining a location of said at least one property based on input from said at least one potential buyer;
a communications module for providing at least one communications channel between said at least one potential buyer and said at least one potential seller;
wherein at least some of said entries in said property database are based on said location of said at least one property.

138: The method according to claim 137, wherein said input from said user used to determine said selected property's location is at least one of:
a digital image of said selected property;
an address of said selected property;
an address of a general area for said selected property;
an address of a nearest cross-street to said selected property; and
a GPS location of said at least one potential buyer when said at least one potential buyer is adjacent said selected property.

139: The method according to claim 137, wherein said location for said selected property is determined by at least one of:
comparing a digital image of said selected property with digital images of properties in a general location of said selected property;
referencing at least one online mapping application;
referencing a GPS location of said user when said user is adjacent to said selected property; and
providing said user with at least one test location for said selected property and receiving further input from said user that corrects said at least one test location to said location for said selected property.

140: The method according to claim 137, wherein said user is one of: a potential buyer of said selected property, a potential seller of said property, and a professional involved in sales or transfers of said selected property.

141: The method according to claim 137, wherein said developments relating to said selected property include at least one of:
a listing of said selected property as being for sale;
a listing of said selected property as being for rent;
a registration of a mortgage on said selected property;
a sale of a property near said selected property;
a rental of a property near said selected property;
publication of at least one news article regarding an area where said selected property is located; and
a registration of a lien against said selected property.

142: The method according to claim 137, wherein said step of tracking developments relating to said selected property step comprises accessing databases external to a system implementing said method to thereby gather data regarding said developments, and
wherein said databases external to said system include at least one of:
a municipal database containing tax property records;
a database for open real estate listings; and
a database for completed real estate listings.

143: The method according to claim 137, wherein said method further comprises providing recommendations for specific professionals to provide services to at least one of said potential buyer and said potential seller.

144: The method according to claim 137, wherein said identity of said potential buyer is only revealed to said potential seller upon receipt of an express permission from said potential buyer to do so.

145: The method according to claim 137 further including a step of extracting parameters for said selected property and determining user preferences for properties based on said parameters, said step of extracting parameters and determining user preferences being accomplished using machine learning.
